(19) United States
(12) Patent Application Publication
(10) Pub. No.: US 2007/0194489 A1
(43) Pub. Date: Aug. 23, 2007

(54) Method of manufacturing resin molded product

(75) Inventors: Tadayoshi Shimoyama, Tokyo (JP); Yukiyasu Arakawa, Tokyo (JP); Yuji Ideshita, Yokohoma-shi (JP); Yukitomo Yuhara, Abiko-shi (JP)

Correspondence Address: BIRCH STEWART KOLASCH & BIRCH, PO BOX 747, FALLS CHURCH, VA, 22040-0747, US

(73) Assignee: Yoshida Industry Co., Ltd., Tokyo (JP)

(21) Appl. No.: 11/707,073

(22) Filed: Feb. 16, 2007

(30) Foreign Application Priority Data
Feb. 20, 2006 (JP) 2006-042374
Feb. 20, 2006 (JP) 2006-042375

(51) Int. Cl. B29C 45/00

(52) U.S. Cl. 264/255; 264/328.8

(57) ABSTRACT

A resin molded product manufacturing apparatus includes, a movable mold having a pair of movable side cavity and side gate formed symmetrically with respect to an axis; a fixed mold having a fixed side primary cavity and a fixed side secondary cavity; and primary and secondary resin injecting units and a decorating film carrying unit disposed on the fixed mold. The manufacturing method includes closing the molds and injecting primary resin into the fixed side primary cavity to form a primary resin molded product; opening the molds and rotating the movable mold around the rotation axis symmetrically with respect to the axis; and, with a decorating film placed on the fixed side secondary cavity, closing the molds and injecting secondary resin from the side gate between the movable side cavity and the fixed side secondary cavity to form a decorated secondary resin molded product.

### CROSS-REFERENCE TO RELATED APPLICATION

This application claims the benefit of priority from the prior Japanese Patent Application Nos. 2006-42374 and 2006-42375, the entire contents of which are incorporated by reference herein.

### BACKGROUND OF THE INVENTION

1. Field of the Invention

The present invention relates to a method of manufacturing resin molded product for double molding by injecting two kinds of synthetic resins each having a different material and color tone.

2. Description of the Related Art

Conventionally, double molding has been performed by injecting two kinds of synthetic resins each having a different material and color tone. (see, for example, Japanese Patent Application Laid-Open Nos. 9-183139, 9-183140, 9-183141 and 9-183142).

According to these conventional technologies, an injection molding machine is disposed on the side of a fixed mold and a carrying unit for a decorating sheet is disposed integrally on the side of a movable mold. The resin molded product is formed as follows. First, a primary resin molded product is obtained by injecting resin on a primary side, thereafter, the movable mold is rotated to a position in which resin for a secondary side is to be injected. Next, after the molds are closed, the resin for the secondary side is injected so as to obtain a secondary resin molded product.

However, if a heavy construction such as the decorating sheet carrying unit is disposed on the side of the movable mold which is rotated as described above, a large rotary driving force is needed.

Although it can be considered to use a small decorating sheet carrying unit as described in the patent document in order to solve this problem, the decorating sheet itself becomes small so that the freedom of the decorating sheet may be deteriorated. If the driving force of a driving means is increased, the driving means itself becomes large to lead enlargement in the size of the manufacturing apparatus thereby worsening efficiency.

Further, when the movable mold is rotated together with the decorating sheet carrying unit, the position of the decorating sheet and the position of a cavity in the mold may deflect from each other with a motion thereof. If positions of decoration and cavity deflect from each other, decoration cannot be performed accurately on a resin molded product.

### SUMMARY OF THE INVENTION

An object of the present invention is to provide a manufacturing method for obtaining a resin molded product having a high design property by double molding system.

To achieve the above-described object, according to an aspect of the present invention, there is provided a method of manufacturing resin molded product using a manufacturing apparatus including: a movable mold in which a pair of a movable side cavity and a side gate are formed symmetrically with respect to an axis; a fixed mold in which a fixed side primary cavity and a fixed side secondary cavity are formed; a primary resin injecting means and a secondary resin injecting means disposed on the side of a fixed mold; and a decorating film carrying means disposed on the side of the fixed mold, the method including: a primary forming step of closing the movable mold with respect to the fixed mold and injecting primary resin into the fixed side primary cavity by the primary resin injecting means so as to form a primary resin molded product; a rotating step of opening the molds to separate the movable mold from the fixed mold with the primary resin molded product held and rotating the movable mold around the rotation axis symmetrically with respect to the axis; and a secondary forming step of, with a decorating film of the decorating film carrying means placed on the fixed side secondary cavity, closing the movable mold with respect to the fixed mold and injecting secondary resin from the side gate between the movable side cavity and the fixed side secondary cavity by the secondary resin injecting means so as to form a decorated secondary resin molded product.

According to another aspect of the present invention, there is provided a method of manufacturing resin molded product using a manufacturing apparatus including: a movable mold in which a pair of a movable side cavity and a side gate are formed symmetrically with respect to an axis; a fixed mold in which a fixed side primary cavity and a fixed side secondary cavity are formed; a primary resin injecting means and a secondary resin injecting means disposed on the side of a fixed mold; and a decorating film carrying means disposed on the side of the fixed mold, the method including: a primary forming step of closing the movable mold with respect to the fixed mold and injecting primary resin from a pin gate connected to the fixed side primary cavity by the primary resin injecting means so as to form a primary resin molded product; a rotating step of opening the molds to separate the movable mold from the fixed mold with the primary resin molded product held and rotating the movable mold around the rotation axis symmetrically with respect to the axis; and a secondary forming step of, with a decorating film of the decorating film carrying means placed on the fixed side secondary cavity, closing the movable mold with respect to the fixed mold and injecting secondary resin from the side gate between the movable side cavity and the fixed side secondary cavity by the secondary resin injecting means so as to form a decorated secondary resin molded product.

According to still another aspect of the present invention, there is provided a method of manufacturing resin molded product using a manufacturing apparatus including: a movable mold in which a movable side cavity, primary side gate and secondary side gate are formed on each side symmetrically with respect to the axis; a fixed mold in which a fixed side primary cavity and a fixed side secondary cavity are formed; a primary resin injecting means and a secondary resin injecting means disposed on the side of a fixed mold; and a primary decorating film carrying means and secondary decorating film carrying means disposed on the side of the fixed mold, the method including: a primary forming step of, with a primary decorating film of the primary decorating film carrying means placed on the fixed side primary cavity on the fixed mold, closing the movable mold with respect to the fixed mold and injecting primary resin from the primary side gate between the movable side cavity and the fixed side primary cavity by the primary resin injecting means so as to form a primarily decorated primary resin molded product; a rotating step of opening the molds to separate the movable mold from the fixed mold with the primary resin molded product held and rotating the movable mold around the rotation axis symmetrically with respect to the axis; and a secondary forming step of, with a secondary decorated film of the secondary decorated film carrying means placed on the fixed side secondary cavity on the fixed side mold, closing the movable mold with respect to the fixed mold and injecting secondary resin from the secondary side gate between the movable side cavity and the fixed side secondary cavity by the secondary resin injecting means so as to form a secondarily decorated secondary resin molded product.

According to the method of manufacturing resin molded product of the present invention, as described above, by providing the heavy resin injecting means and decorating film carrying means on the side of the fixed mold, the weight of the movable mold is small thereby facilitating a rotation of the movable mold. Consequently, the driving force can be reduced and the resin molded product can be obtained efficiently.

Further, by closing the molds and injecting resin, two resin molded products of primary resin molded product and secondary resin molded product can be formed at the same time. Because the side gate is used on the secondary side, resin can be injected into the cavity with the decorating film placed on the cavity. Thus, a resin molded product having a high design property can be obtained.

To achieve the above object, the method of manufacturing resin molded product of the present invention may use any one of the primary decorating film carrying means and the secondary decorating film carrying means.

As described above, according to the method of manufacturing resin molded product of the present invention, the design property of the resin molded product can be adjusted by using any one of the primary decorating film carrying means and the secondary decorating film carrying means.

### BRIEF DESCRIPTION OF THE DRAWINGS

FIG. 1 is a front view of a manufacturing apparatus according to a first embodiment;

FIG. 2 is a sectional view of the manufacturing apparatus as seen from above (sectional view taken along a line A-A of FIG. 1) according to the first embodiment;

FIGS. 3A and 3B are diagrams for explaining a primary forming step for manufacturing (sectional view taken along a line B-B of FIG. 1) according to the first embodiment;

FIGS. 4A and 4B are diagrams for explaining a rotating step for manufacturing according to the first embodiment;

FIGS. 5A and 5B are diagrams for explaining a secondary forming step for manufacturing according to the first embodiment;

FIG. 6 is an enlarged sectional view showing the detailed structure of a cavity on the secondary side according to the first embodiment;

FIG. 7 is an enlarged sectional view showing a submarine gate according to a second embodiment;

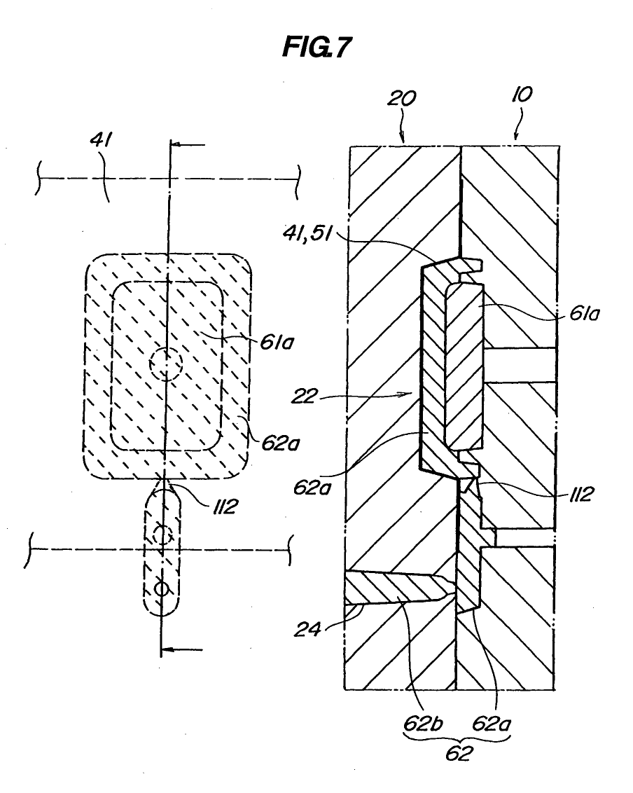

FIG. 8 is an explanatory diagram of a case of using a plurality of templates according to the second embodiment;

FIG. 9 is a front view of the manufacturing apparatus according to a third embodiment;

FIG. 10 is a sectional view of the manufacturing apparatus (sectional view taken along a line A-A of FIG. 1) according to the third embodiment;

FIGS. 11A and 11B are diagrams for explaining a primary forming step for manufacturing (sectional view taken along a line B-B of FIG. 2) according to the third embodiment;

FIGS. 12A and 12B are diagrams for explaining a rotating step for manufacturing according to the third embodiment;

FIGS. 13A and 13B are diagrams for explaining a secondary forming step for manufacturing according to the third embodiment;

FIG. 14 is an enlarged sectional view showing the detailed structure of a cavity on a secondary side according to the third embodiment;

FIGS. 15A and 15B are diagrams showing the structure of decorating only one side according to a fourth embodiment;

FIG. 16 is an enlarged sectional view showing the submarine gate according to the fourth embodiment; and

FIG. 17 is an explanatory diagram of a case of using a plurality of templates according to the fourth embodiment.

### DESCRIPTION OF THE PREFERRED EMBODIMENTS

### First Embodiment

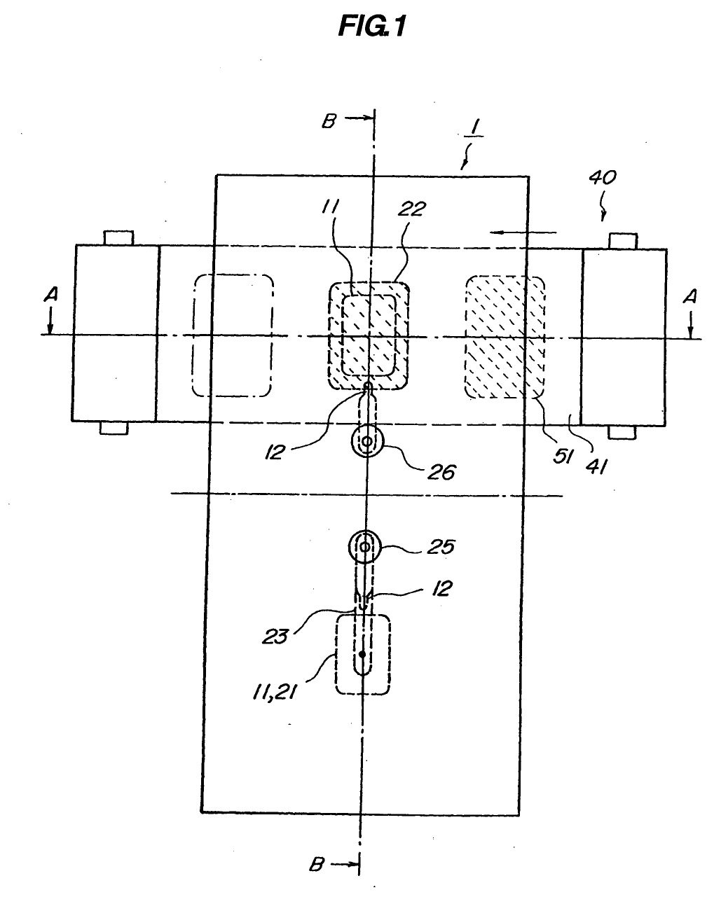

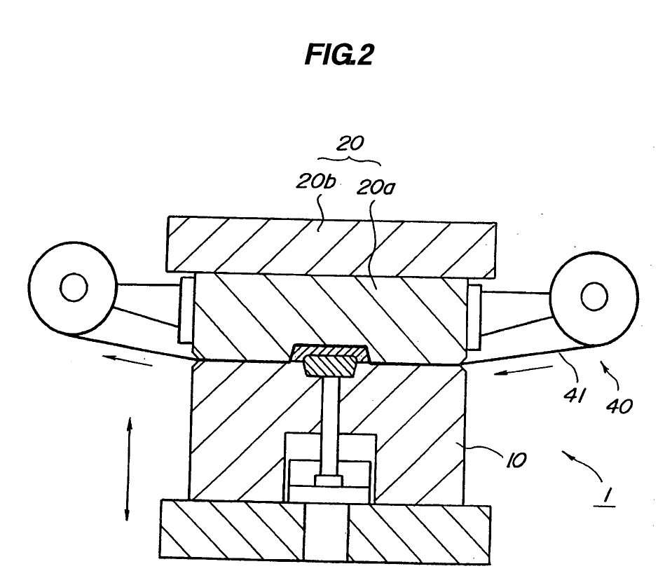

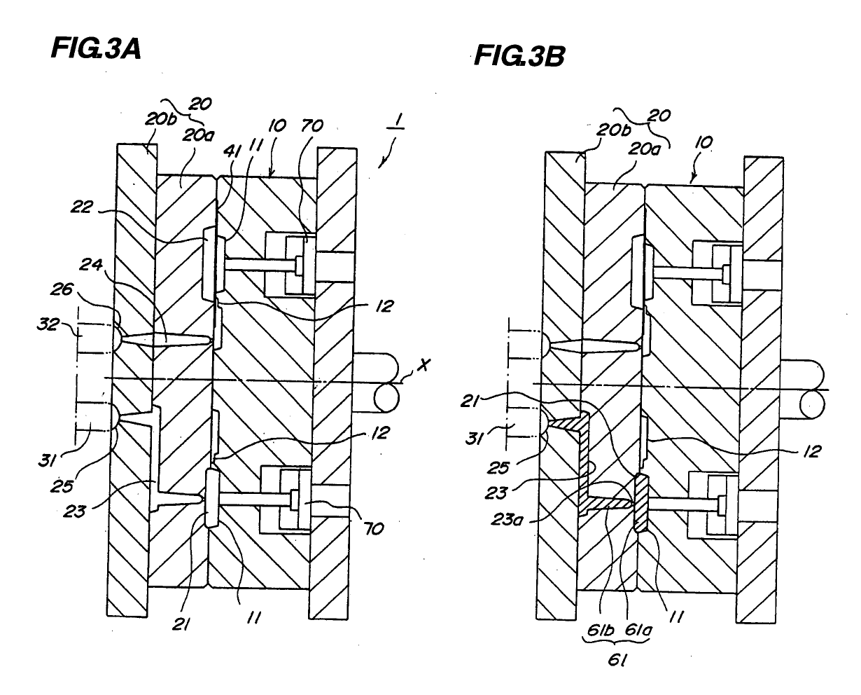

The embodiment of the present invention will be described with reference to the accompanying drawings. (Manufacturing apparatus) The structure of the manufacturing apparatus will be described with reference to FIGS. 1 to 3B. FIG. 1 is a front view of the manufacturing apparatus. FIG. 2 is a sectional view of the manufacturing apparatus as seen from above (sectional view taken along a line A-A of FIG. 1). FIGS. 3A and 3B are sectional views of the manufacturing apparatus as seen from sideway (sectional view taken along a line B-B of FIG. 1).

As shown in FIGS. 1 to 3B, the manufacturing apparatus 1 for resin molded product includes a movable mold 10 each having two movable side cavities 11 and side gates 12 and a fixed mold 20 having a fixed side primary cavity 21 and a fixed side secondary cavity 22. The fixed mold 20 includes a forming mold 20a having the cavities 21, 22 and resin introduction paths 23, 24 and a pouring mold 20b having resin pouring ports 25, 26.

As shown in FIG. 2, the manufacturing apparatus 1 has a decorating film carrying means 40 for carrying a decorating film 41, provided integrally with the fixed mold 20. It further has two resin injecting means of a primary resin injecting means 31 and a secondary resin injecting means 32, provided integrally with the fixed mold 20. Resin is poured into the fixed mold 20 from an opposite side to the movable mold 10.

As shown in FIGS. 1 to 3B, a plurality of cavities are formed in the movable mold 10 and the fixed mold 20. Next, the detail of the manufacturing apparatus will be described.

The movable side cavity 11 for forming a primary resin molded product is formed in the movable mold 10 symmetrically with a rotation axis X. The side gate 12 which does not communicate directly with the movable cavity 11 is formed sideway of the movable cavity 11.

The fixed side primary cavity 21 for forming a primary resin molded product and the fixed side secondary cavity 22 for forming a secondary resin molded product are disposed in the fixed mold 20. The fixed side primary cavity 21 is disposed at a position opposing the movable side cavity 11 on the primary side. Further, the fixed side secondary cavity 22 is disposed to oppose the movable side cavity 11 on the secondary side and communicate with the movable side cavity 11 and the side gate 12 at the same time.

As shown in FIGS. 1 to 3B, a primary resin introduction path 23 and a primary resin pouring port 25 for introducing primary resin to the fixed side primary cavity 21 are formed on the primary side of the fixed mold 20. A secondary resin introduction path 24 and a secondary resin pouring port 26 for introducing secondary resin to the fixed side secondary cavity are formed on the secondary side of the fixed mold 20. Consequently, resin is poured into the cavity.

As shown in FIGS. 3A and 3B, a primary resin injecting means 31 for injecting primary resin is disposed at the primary resin pouring port 25 and the secondary resin injecting means 32 for injecting secondary resin is disposed at the entrance of the secondary resin introduction path 24. The materials of the primary resin and secondary resin may be of different kind or color or may be of the same one.

The decorating film carrying means 40 is fixedly disposed on both side faces of the fixed mold 20. The decorating film carrying means 40 has a feeding side roller and a receiving side roller and carries the decorating film 41 on which a pattern 51 is printed continuously in the direction of an arrow indicated in the figure.

(Manufacturing Method)

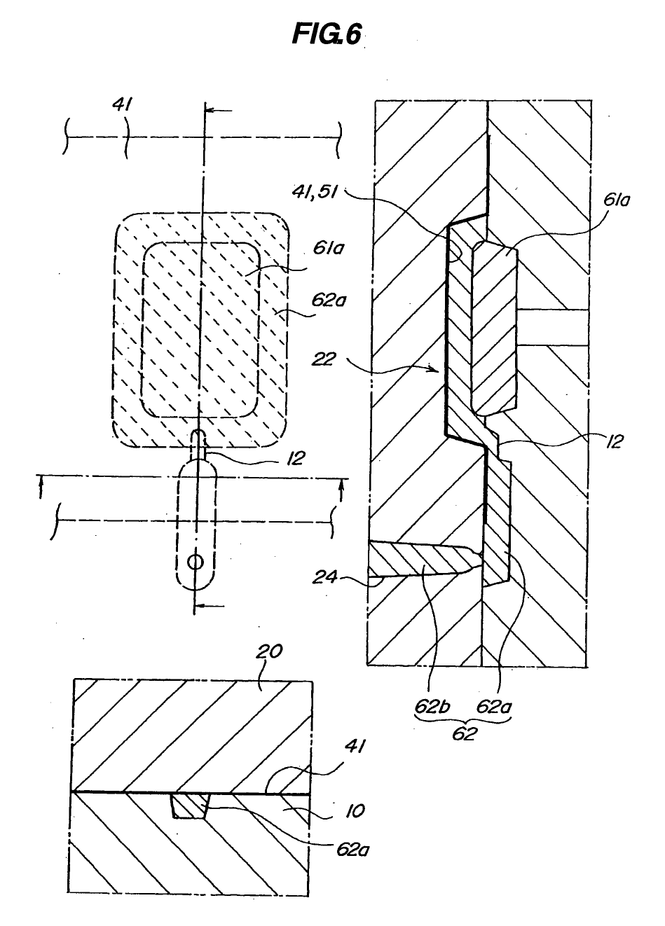

The method of manufacturing the resin molded product will be described with reference to FIGS. 3A to 6. FIGS. 3A to 5B are diagrams for explaining motions of the movable mold 10 and fixed mold 20 at the time of manufacturing and FIG. 6 is an enlarged sectional view showing the detailed structure of the cavity on the secondary side.

Primary forming process for forming the primary resin molded product will be described with reference to FIGS. 3A and 3B.

First, as shown in FIG. 3A, the movable mold 10 is closed with respect to the fixed mold 20. Next, as shown in FIG. 3B, molten primary resin is injected from the primary resin pouring port 25 by the primary resin injecting means 31. The injected primary resin passes through the exit 23a of the primary resin introduction path 23 which serves as a pin gate and is charged in between the movable side cavity 11 and the fixed side primary cavity 21 directly from the side of the fixed mold 20. By such a procedure, a primary resin member 61 in which a primary resin molded product 61a charged in the cavity and a primary sprue 61b charged in the primary resin introduction path 23 are integrated is obtained.

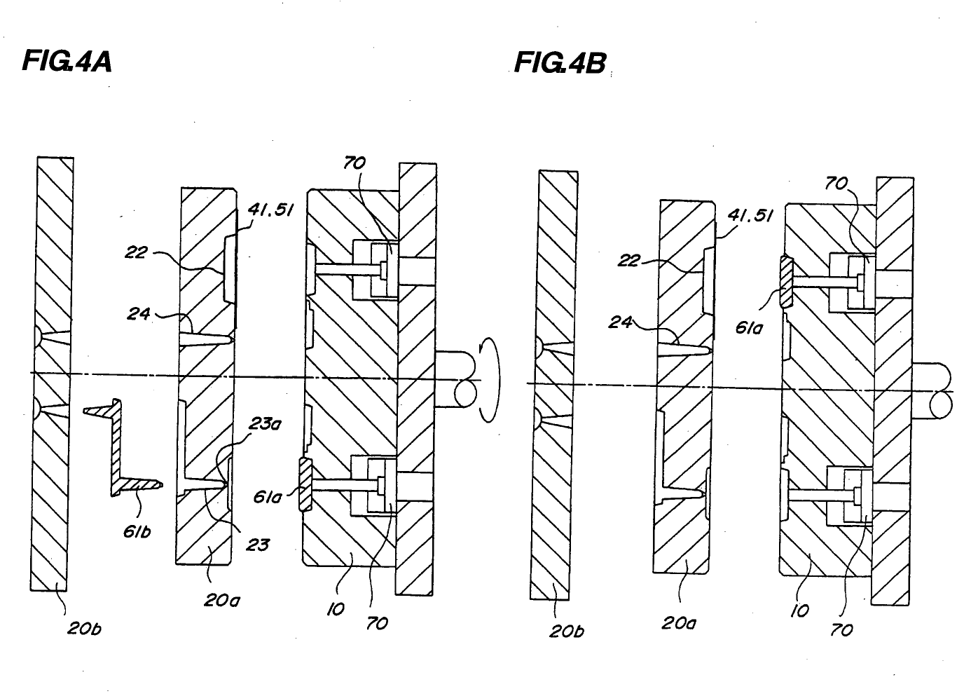

Rotating step for rotating the primary resin molded product 61a will be described with reference to FIGS. 4A and 4B.

As shown in FIG. 4A, with the cooled primary resin member 61 held, the movable mold 10 is separated from the fixed mold 20 and opened. At this time, in the fixed mold 20 also, the forming mold 20a and the pouring mold 20b are separated and opened.

When the movable mold 10 and the forming mold 20a are separated from each other, the primary resin molded product 61a is separated from the primary sprue 61b at the exit 23a in which the primary resin introduction path 23 is squeezed. Further, when the forming mold 20a and the pouring mold 20b are separated, space is generated between the primary resin introduction path 23 and the pouring mold 20a, so that the primary sprue 61b can be brought out of the fixed mold 20. Consequently, the primary resin molded product 61a is molded.

Next, as shown in FIG. 4A, a driving means (not shown) is driven. By this drive, as shown in FIG. 4B, the movable mold 10 is rotated by 180° around the rotation axis X symmetrically with respect to the axis. Then, the primary resin molded product 61a is moved to a position opposing the fixed side secondary cavity 22. In this condition, the decorating film 41 is carried together with the pattern 51 (see FIG. 1) and placed on the fixed side secondary cavity 22 in the fixed mold 20.

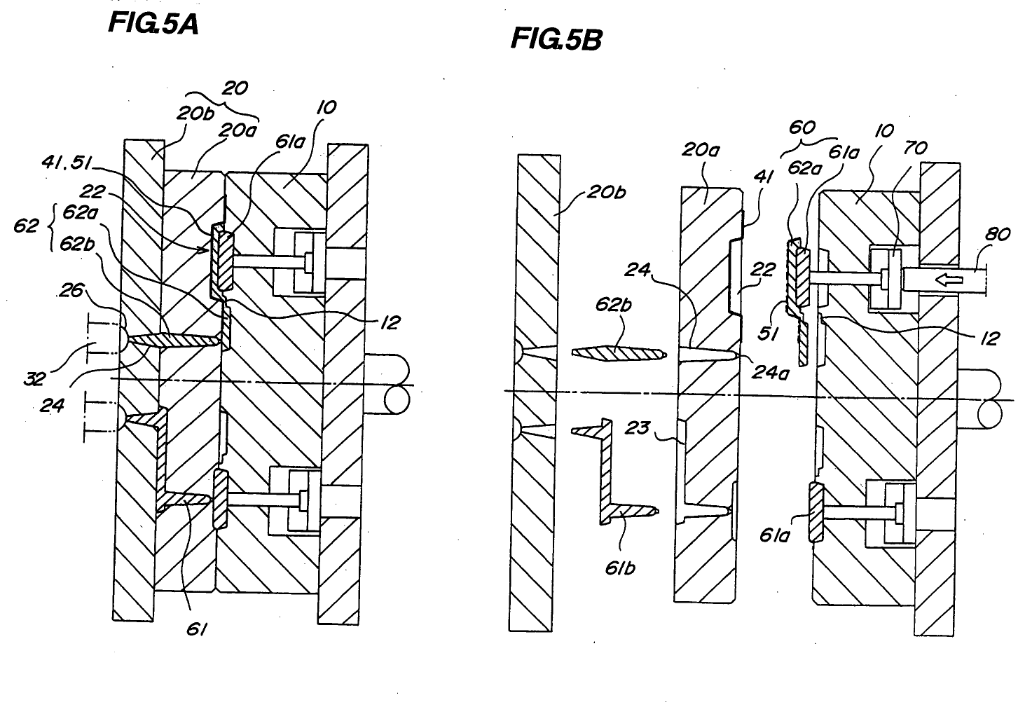

Secondary forming step for forming the secondary resin molded product will be described with reference to FIGS. 5A to 6.

With the decorating film 41 placed on the fixed side secondary cavity 22 in the fixed mold 20 (see FIG. 4B), the movable mold 10 is moved relative to the fixed mold 20 and closed (see FIG. 5A)

Next, as shown in FIGS. 5A to 6, secondary resin is injected from the secondary resin pouring port 26 by the secondary resin injecting means 32. The injected secondary resin passes through the interior of the secondary resin introduction path 24 and the side gate 12, so that it invades in between the primary resin molded product 61a and the decorating film 41 and is charged in the fixed side secondary cavity 22.

The pattern 51 (see FIG. 1) printed to the decorating film 41 is transferred to the secondary resin by heat and pressure of the secondary resin charged in the molten state. In this procedure, a secondary resin portion 62a charged in the cavity and a secondary sprue 62b charged in the secondary resin introduction path 24 are obtained. As shown in FIG. 5A, the primary resin member 61 is obtained on the primary side in the same process as described previously. Consequently, continuous formation is enabled.

After the secondary forming, as shown in FIG. 5B, with the cooled secondary resin member 62 (including the secondary resin portion 62a and the secondary sprue 62b), the movable mold 10 and the fixed mold 20 are separated and opened. At this time, in the fixed mold 20 also, the forming mold 20a and the pouring mold 20b are separated from each other.

When the movable mold 10 and the forming mold 20a are separated, the secondary resin portion 62a and the secondary sprue 62b are separated at the exit 24a in which the secondary resin introduction path 24 is squeezed. When the molds are separated in this procedure, the secondary sprue 62b is removed from the secondary resin molded product in which the primary resin molded product 61a and the secondary resin portion 62a are integrated.

When the forming mold 20a and the pouring mold 20b are separated, space is generated between the secondary resin introduction path 24 and the pouring mold 20b, so that the secondary sprue 62b can be taken out of the fixed mold 20.

A pushing member 70 disposed adjacent the movable side cavity 11 and the side gate 12 is pressed by a pressing means 80 shown in FIG. 5B. Consequently, the secondary resin molded product 60 is removed from the movable side cavity 11. After that, the sprue and runner are removed from the secondary resin molded product 60. Consequently, a resin molded product is completed.

As described above, according to this embodiment, diversified resin molded products can be obtained by combining the two resin members 61a, 61b. Specifically, if any one or both of the primary resin member 61a and the second resin portion 62a are composed of transparent or translucent member, further diversified patterns can be formed.

According to this embodiment, resin is poured into the cavity in the secondary side through the side gate 12. Consequently, the resin molded product can be formed using the decorating film 41. As a result, the pattern of the resin molded product is diversified thereby improving design property.

In this embodiment, the resin injecting means 31, 32 having a heavy weight and the decorating film carrying means 40 are disposed on the side of the fixed mold 20. Because no heavy means is disposed on the side of the movable mold 10, the movable mold 10 is light so that the driving force of the driving means for rotating or moving the movable mold 10 can be reduced. Thus, the movable mold 10 can be moved efficiently by a small driving force and consequently, the resin molded product can be obtained effectively.

In this embodiment, the decorating film carrying means 40 is disposed on the side of the fixed mold 20. If the decorating film 41 is carried and positioned at a predetermined position by the decorating film carrying means 40, the position of the decorating film 41 is fixed securely until resin is injected. Then, the accuracy of a pattern transferred position is raised compared with a case where the decorating film carrying means is rotated together with the movable mold. As a result, the position of the pattern to be transferred to resin becomes accurate thereby securing high design property of the resin molded product.

### Second Embodiment

Although the configuration of the gate to the cavity in the secondary side is of the side gate 12 in the first embodiment, that gate is not limited to this example. For example, it is permissible to adopt a submarine gate 112 by squeezing part of the aforementioned side gate 12. In this case, if the movable mold 10 and the fixed mold 20 are separated, the secondary resin is separated at the squeezed portion. Consequently, step of removing a runner after the secondary resin molded product is obtained can be omitted thereby making the manufacturing process more effective.

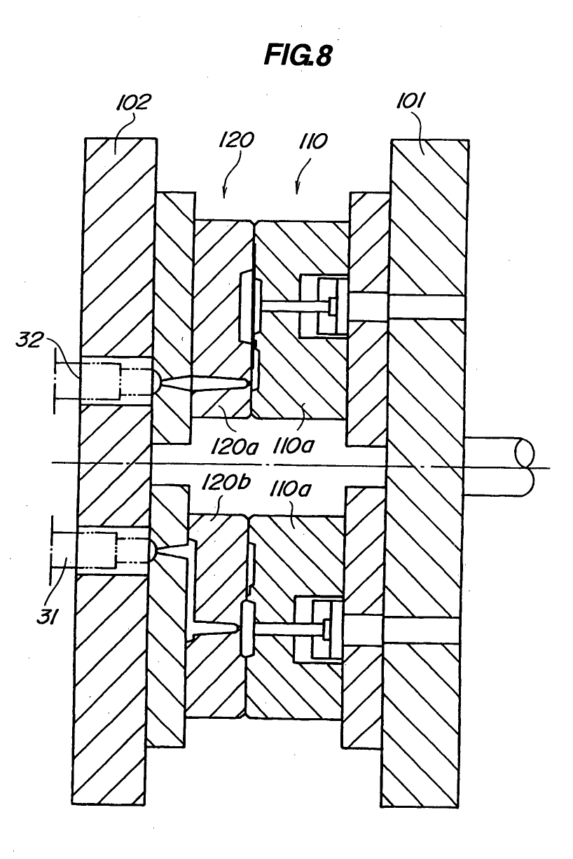

Although in the first embodiment, the two cavities 21, 22 and the two introduction paths 23, 24 are constructed integrally in one fixed mold 20, this embodiment is not restricted thereto. For example, as shown in FIG. 8, a fixed mold 120 to be fixed to a base 102 may be constituted of a plurality of templates. In this embodiment, the fixed mold 120 is constituted of two templates of a fixed side primary template 120a and a fixed side secondary template 120b.

Further, although in the first embodiment, the two cavities 11 and the two gates 12 are constructed integrally in the movable mold 10, this embodiment is not restricted thereto For example, as shown in FIG. 8, a movable mold 110 maybe divided to two templates 110a and the respective templates 110a may be disposed symmetrically with respect to the axis. Here, reference numeral 110 denotes a rotating disk.

By constituting the mold with a plurality of independent templates, temperature control on each template can be performed. If the temperature control of the primary side and secondary side templates is carried out individually, the temperature of each template can be controlled to a temperature suitable for each step. As a result, a precision, more stable resin molded product can be obtained.

### Third Embodiment

The embodiment of the present invention will be described with reference to the accompanying drawings.

(Manufacturing Apparatus)

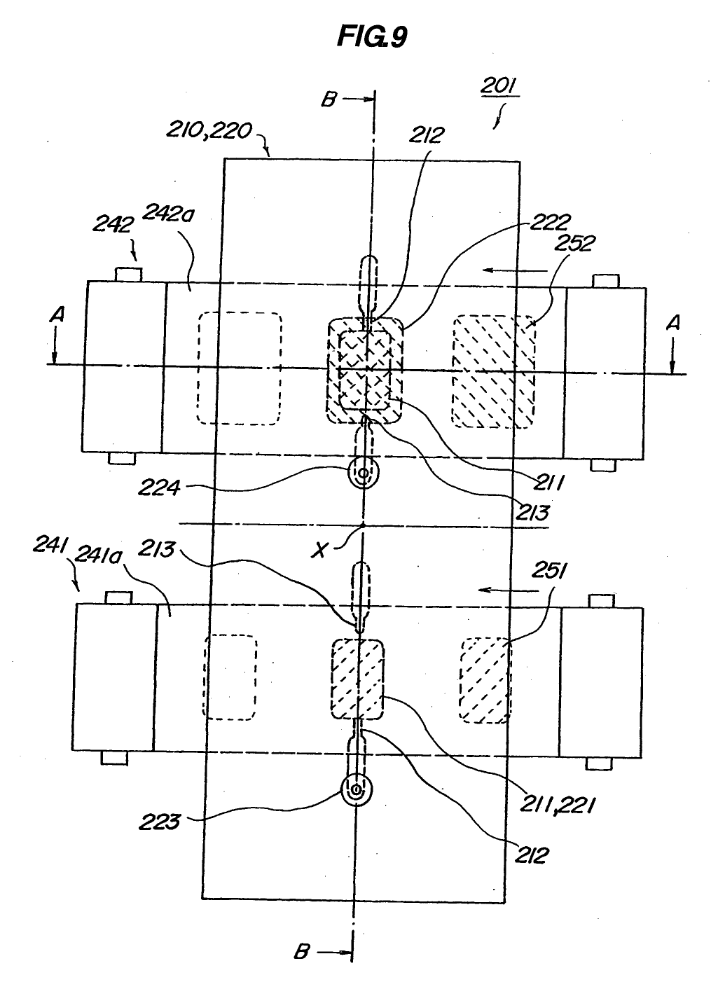

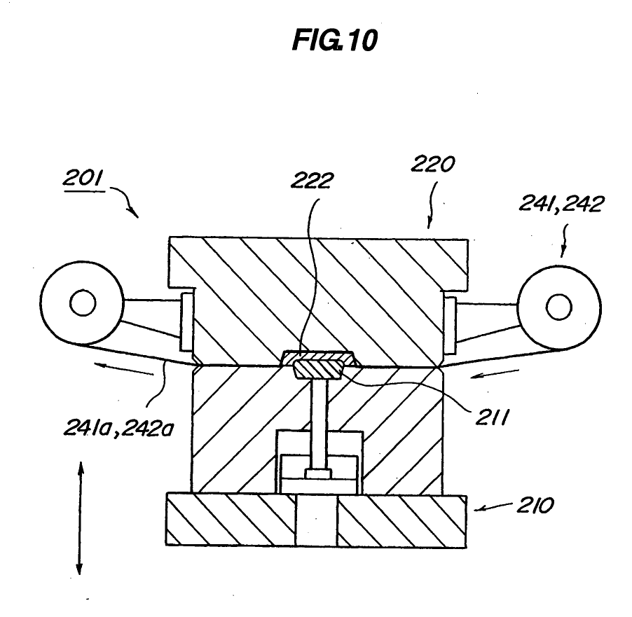

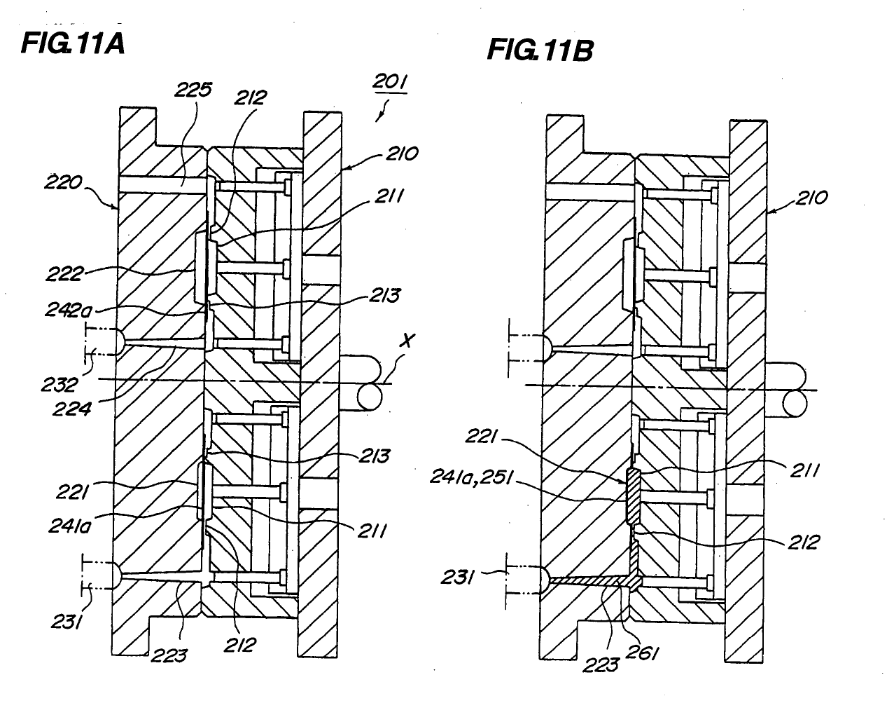

The structure of the manufacturing apparatus will be described with reference to FIGS. 9 to 11B. FIG. 9 is a front view of the manufacturing apparatus, FIG. 10 is a sectional view of the manufacturing apparatus as seen from above (sectional view taken along a line A-A of FIG. 9) and FIGS. 11A and 11B are a sectional view of the manufacturing apparatus as seen from sideway (sectional view taken along a line B-B of FIG. 9).

As shown in FIGS. 9 to 11B, the manufacturing apparatus 201 for resin molded product includes a movable mold 210 having two cavities 211 and gates 212, 213 and a fixed mold 220 having cavities 221, 222.

As shown in FIG. 10, the manufacturing apparatus 201 includes a primary decorating film carrying means 241 and a secondary decorating film carrying means 242 provided integrally with the fixed mold 220. Further, as shown in FIGS. 11A and 11B, it includes a primary resin injecting means 231 and a secondary resin injecting means 232 provided integrally with the fixed mold 220. Consequently, resin is poured into the fixed mold 220 from an opposite side to the movable mold 210.

As shown in FIGS. 9 to 11B, the movable mold 210 and the fixed mold 220 include a plurality of cavities.

The movable side cavities 211 for forming the primary resin molded product are disposed in the movable mold 210 symmetrically with respect to the rotation axis X. Two side gates are disposed on the sides of the movable side cavity 211. That is, the primary side gate 212 is disposed on a far side relative to the rotation axis X and the secondary side gate 213 is disposed on a near side relative to the rotation axis X.

A fixed side primary cavity 221 for forming the primary resin molded product and a fixed side secondary cavity 222 for forming the secondary resin molded product are disposed in the fixed mold 220. The positions of the respective cavities 221, 222 are opposite to the two movable side cavities 211 in the aforementioned movable mold 210.

As shown in FIGS. 9 to 11B, the fixed mold 220 has a primary resin introduction port 223 for introducing primary resin to the fixed side primary cavity 221 through the primary side gate 212 and a secondary resin introduction port 224 for introducing secondary resin to the fixed side secondary cavity through the secondary side gate 213. Further, as shown in FIGS. 11A and 11B, a recessed hole 225 for sprue on the primary side to enter at the time of formation is formed as shown in FIGS. 11A and 11B.

As shown in FIG. 11A, the primary resin injecting means 231 for injecting primary resin is disposed at an entrance of the primary resin introduction port 223 and the secondary resin injecting means 232 for injecting secondary resin is disposed at an entrance of the secondary resin introduction port 224. The materials of the primary resin and secondary resin may be of different kind or color or may be of the same one.

Two decorating film carrying means 241, 242 are disposed on both side faces of the fixed mold 220 as shown in FIG. 10. Each decorating film carrying means has a feeding side roller and a receiving side roller, which carry a decorating film on which a pattern is printed continuously.

As shown in FIG. 9, the primary decorating film carrying means 241 is disposed on both side faces of the fixed side primary cavity 220 and the primary decorating film 241a on which the primary side pattern 251 is printed is carried in the direction of an arrow in the figure. Likewise, the secondary decorating film carrying means 242 is disposed on both side faces of the fixed side secondary cavity 222 and the secondary decorating film 242a on which the secondary side pattern 252 is printed is carried in the direction of an arrow in the figure.

(Manufacturing Method)

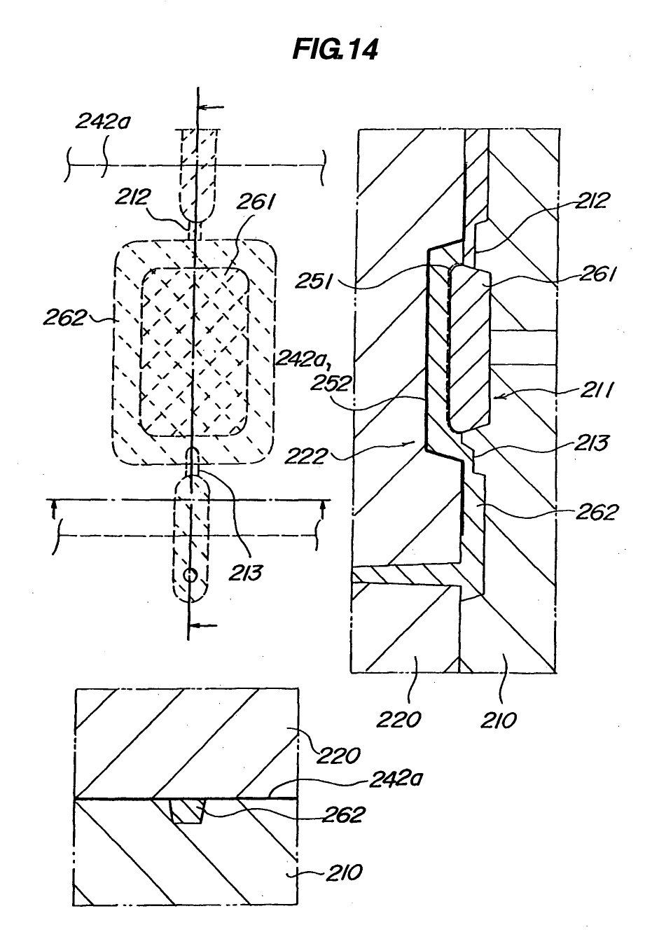

The method of manufacturing resin molded product will be described with reference to FIGS. 11A to 14. FIGS. 11A to 13B are diagrams for explaining the motions of the movable mold 210 and the fixed mold 220 at the time of manufacturing and FIG. 14 is an enlarged sectional view showing the detailed structure of the secondary side cavity.

Primary forming step of forming the primary resin molded product will be described with reference to FIGS. 11A and 11B.

First, as shown in FIG. 11A, the primary decorating film 241a of the primary decorating film carrying means 241 is placed on the fixed side primary cavity on the fixed mold 20. Then, in this condition, the movable mold 210 is closed relative to the fixed mold 220.

Next, as shown in FIG. 11B, molten primary resin is injected by the primary resin injecting means 231. The injected primary resin passes through the interior of the primary resin introduction port 223 and the primary side gate 212 and is charged in between the movable side cavity 211 and the fixed side primary cavity 221.

The pattern 251 (see FIG. 9) printed to the primary decorating film 241 is transferred (primarily decorated) to the primary resin by heat and pressure of the primary resin charged in the molten state. In this procedure, primary decoration is performed so that a primary resin molded product 261 is obtained.

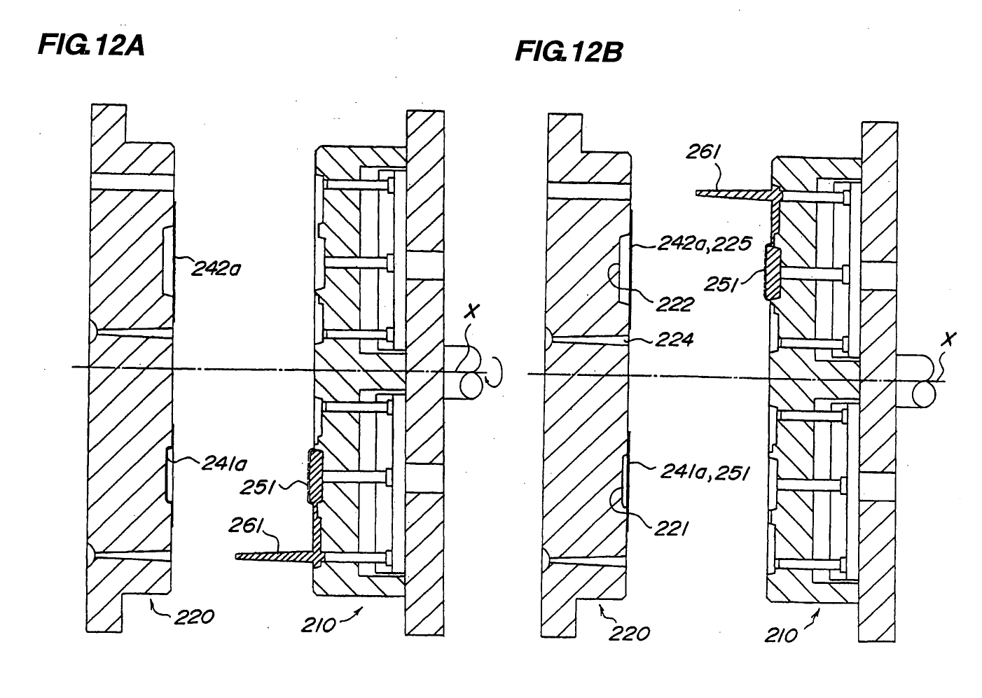

Rotating step for rotating the primary resin molded product 261 us explained with reference to FIGS. 12A and 12B.

As shown in FIG. 12A, with the cooled primary resin molded product 261 held, the movable mold 210 is separated from the fixed mold 220 and opened.

Next, as shown in FIG. 12A, a driving means (not shown) is driven. By this drive, as shown in FIG. 12B, the movable mold 210 is rotated by 180° around the rotation axis X symmetrically with respect to the axis. In this condition, the primary decorating film 241a and secondary decorating film 242a are carried together with the patterns 251, 252 and placed on the cavities 221, 222 of the fixed mold 220.

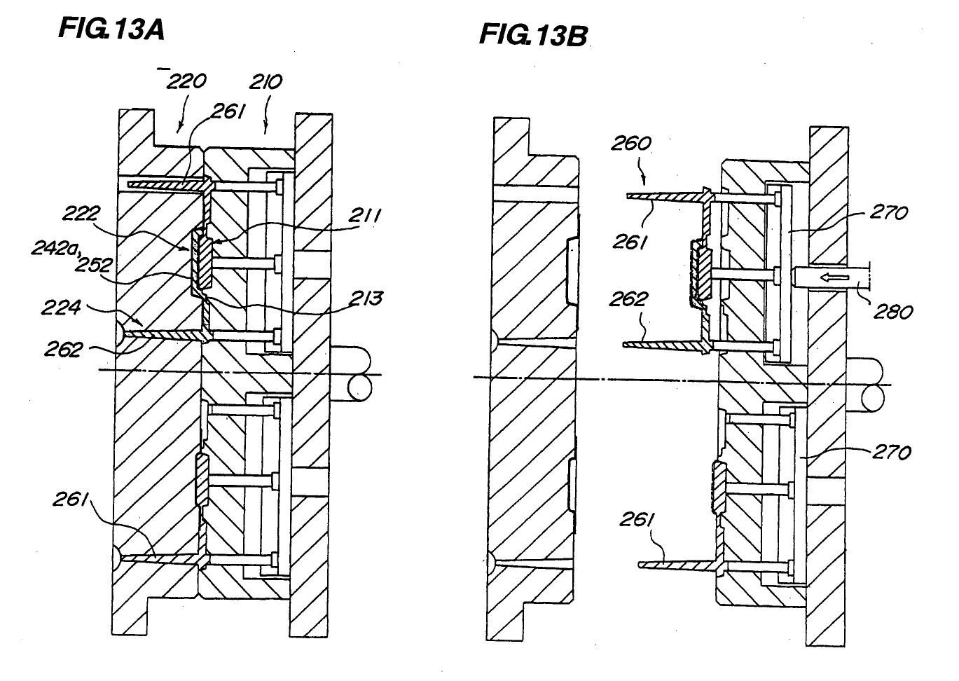

Secondary forming step of forming the secondary resin molded product will be described with reference to FIGS. 13A to 14.

First, with the secondary decorating film 242a placed on the fixed side secondary cavity 222 on the fixed mold 220, as shown in FIG. 13A, the movable mold 210 is moved relative to the fixed mold 220 and closed.

Next, as shown in FIG. 13A and FIG. 14, the secondary resin is injected by the secondary resin injecting means 232. The injected secondary resin passes through the interior of the secondary resin introduction port 224 and then the secondary side gate 213 and invades in between the primary resin molded product 261 and the secondary decorating film 242a so that it is filled in the fixed side secondary cavity 222. In the meantime, as shown in FIG. 13A, the primary resin molded product 261 is formed in the same process as described previously on the primary side.

The secondary side pattern 252 (see FIG. 9) printed to the secondary decorating film 242a is transferred (secondarily decorated) to the secondary resin by heat and pressure of the secondary resin charged in the molten state. As shown in FIG. 14, the secondary resin member 262 is formed integrally with the first resin molded product 261 by heat and pressure at the time of injection while covering the side on which the primary side pattern 251 is applied of the primary resin molded product 261.

The secondary resin molded product 260 is obtained by integrating the primary resin molded product 261 with the secondary resin member 262 through the secondary forming step. After the secondary forming step, with the cooled secondary resin molded product 260 held, as shown in FIG. 13B, the movable mold 210 is separated from the fixed mold 220 and opened.

A pushing member 270 disposed adjacent the movable side cavity 211, the primary side gate 212 and the secondary side gate 213 is pressed by a pressing means 280 as shown in FIG. 13B. Consequently, the secondary resin molded product 260 is removed from the movable side cavity 211. After that, a sprue and runner contained are removed from the secondary resin molded product 260. As a result, a resin molded product is completed.

As described above, diversified resin molded products can be obtained by overlaying the secondary resin member 262 on the primary resin molded product 261. Particularly, more diversified patterns can be formed by constituting any one or both of the primary resin molded product 261 and the secondary resin member 262 of transparent or translucent member.

In this embodiment, resin is poured into the primary side cavity and the secondary side cavity through the side gates 212, 213. As a result, a resin molded product can be formed by using the two decorating films 241a, 242a.

If the primary side pattern 251 is interposed between the primary resin molded product 261 and the secondary resin member 262 and the primary resin or the secondary resin is composed of transparent member or the like as shown in FIG. 14, the decorating films 241a, 242a are recognized such that they overlap through the secondary resin member 262. Consequently, the patterns of the resin molded product is diversified thereby improving the design property.

In this embodiment, the heavy resin injecting means 231, 232 and the decorating film carrying means 241, 242 are disposed on the side of the fixed mold 220. Because any heavy means is not disposed on the side of the movable mold 210, the weight of the movable mold 210 is small so that the driving force of the driving means for rotating or moving the movable mold 210 can be lowered. Thus, the movable mold 210 can be moved effectively with a small driving force and a resin molded product can be obtained efficiently.

In this embodiment, the decorating film carrying means 241, 242 are disposed on the side of the fixed mold 20. Thus, if the decorating films 241a, 242a are carried and positioned at a predetermined position by the primary decorating film carrying means 241, 242, the positions of the films 241a, 242a are fixed securely until resin is injected. Consequently, the accuracy of a pattern transfer position becomes higher than a case where the decorating film carrying means is rotated and moved together with the movable mold. As a result, the accuracy of the position of the pattern to be transferred to resin is improved thereby maintaining a high design property of the resin molded product.

### Fourth Embodiment

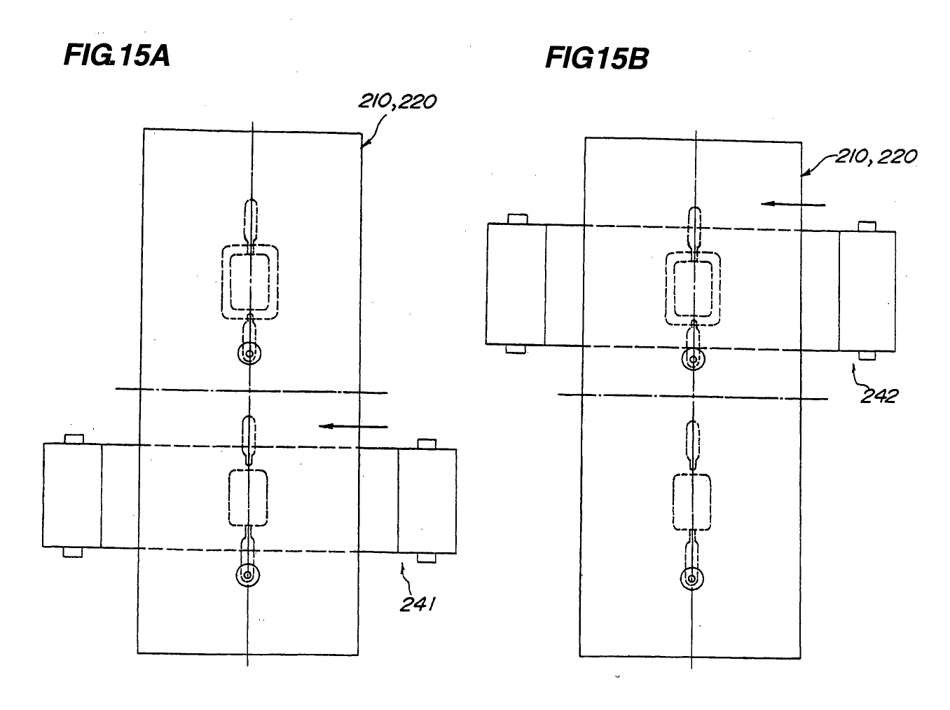

Although in the third embodiment, the decorating film carrying means is used on both the primary side and the secondary side, the embodiment is not limited to this example. For example, a decorating film carrying means 241 may be used on only the primary side as shown in FIG. 15A or may be used on only the secondary side as shown in FIG. 15B.

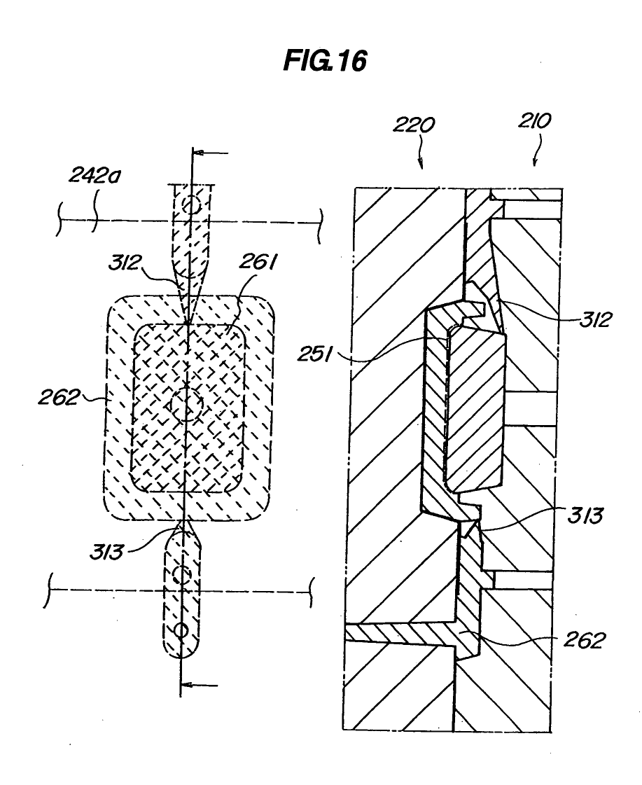

Although in the third embodiment, the side gates are used for both the gates 212, 213 to the cavity, the embodiment is not restricted thereto. For example, as shown in FIG. 16, submarine gates 312, 313 may be formed by squeezing a part of the side gates 212, 213. In this case, the runner and sprue are separated from the resin molded product at the squeezed part when the movable mold 210 and the fixed mold 220 are separated. Consequently, the step of removing the runner after the resin molded product is obtained is omitted thereby leading to making the processing step effective.

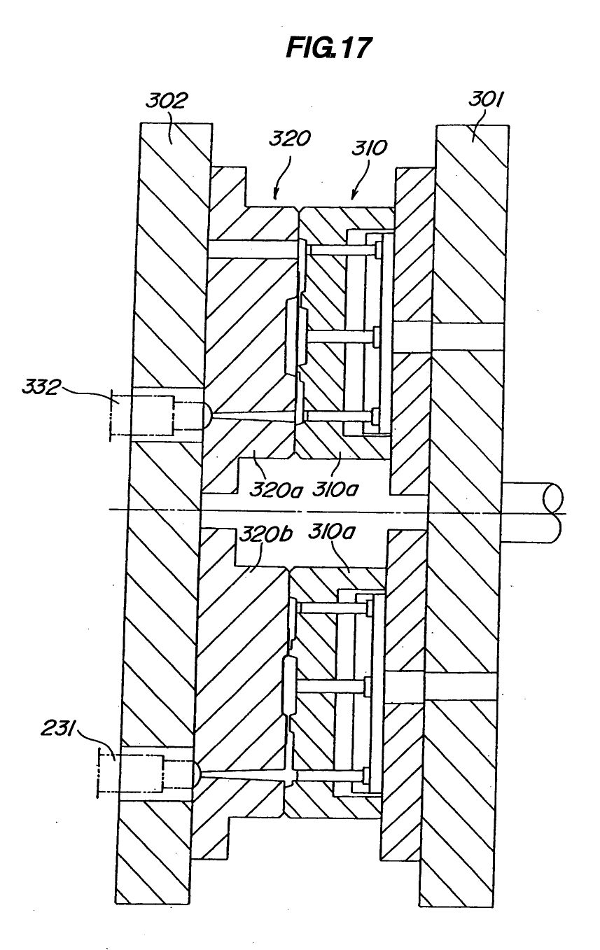

Although in the third embodiment, the two cavities 221, 222 and introduction ports 223, 224 are integrally constructed in one fixed mold 220, the embodiment is not restricted thereto. For example, as shown in FIG. 17, the fixed mold 320 fixed to the base 302 may be constituted of a plurality of templates. In this embodiment, the fixed mold 320 is constituted of two templates of a fixed side primary template 320a and a fixed side secondary template 320b.

Further, although in the third embodiment, the two cavities 211 and two gates 212 are integrally formed in the movable mold 210, the embodiment is not restricted thereto. For example, as shown in FIG. 17, the movable mold 310 may be divided to two independent templates 310a and the respective templates 310a may be disposed symmetrically with respect to the axis.

Here, the reference numeral 301 denotes rotating disk.

By constructing the mold with plural independent templates, the temperature control of each template can be achieved. If the temperature control of the primary side and secondary side templates is carried out independently, the temperature of each template can be controlled to a temperature suitable for each step. As a result, more accurate, stable resin molded product can be obtained.

### DESCRIPTION OF REFERENCE NUMERALS

X: rotation axis, 1: manufacturing apparatus, 10: movable mold, 11: movable side cavity, 12: side gate, 20: fixed mold, 20a: forming mold, 20b: pouring mold, 21: fixed side primary cavity, 22: fixed side secondary cavity, 23: primary side resin introduction path, 23a: exit, 24: secondary resin introduction path, 24a: exit, 25: primary resin pouring port, 26: secondary resin pouring port; 31: primary resin injecting means, 32: secondary resin injecting means, 40: decorating film carrying means, 41: decorating film, 51: pattern, 60: secondary resin molded product, 61: primary resin member, 61a: primary resin molded product, 61b: primary sprue, 62: secondary resin member, 62a: secondary resin portion, 62b: secondary sprue, 70: pushing member, 80: pressing means, 101: rotating disk, 102: base, 110: movable mold, 110a: template, 112: submarine gate, 120: fixed mold, 120a: fixed side primary template, 120b: fixed side secondary template, 201: manufacturing apparatus, 210: movable mold, 211: movable side cavity, 212: primary side gate, 213: secondary side gate, 220: fixed mold, 221: fixed side primary cavity, 222: fixed side secondary cavity, 223: primary resin introduction port, 224: secondary resin introduction port, 225: recessed hole, 231: primary resin injecting means, 232: secondary resin injecting means, 241: primary decorating film carrying means, 241a: primary decorating film, 242: secondary decorating film carrying means, 242a: secondary decorating film, 251: primary side pattern, 252: secondary side pattern, 260: secondary resin molded product, 261: primary resin molded product, 262: secondary resin member, 270: pushing member, 280: pressing means, 301: rotating disk, 302: base, 310: movable mold, 310a: movable side template, 312: submarine gate, 313: submarine gate, 320: fixed mold, 320a: fixed side secondary template, 320b: fixed side primary template

What is claimed is:

1. A method of manufacturing resin molded product using a manufacturing apparatus comprising:
a movable mold in which a pair of a movable side cavity and a side gate are formed symmetrically with respect to an axis;
a fixed mold in which a fixed side primary cavity and a fixed side secondary cavity are formed;
a primary resin injecting means and a secondary resin injecting means disposed on the side of a fixed mold; and
a decorating film carrying means disposed on the side of the fixed mold,
the method comprising:
a primary forming step of closing the movable mold with respect to the fixed mold and injecting primary resin into the fixed side primary cavity by the primary resin injecting means so as to form a primary resin molded product;
a rotating step of opening the molds to separate the movable mold from the fixed mold with the primary resin molded product held and rotating the movable mold around the rotation axis symmetrically with respect to the axis; and
a secondary forming step of, with a decorating film of the decorating film carrying means placed on the fixed side secondary cavity, closing the movable mold with respect to the fixed mold and injecting secondary resin from the side gate between the movable side cavity and the fixed side secondary cavity by the secondary resin injecting means so as to form a decorated secondary resin molded product.

2. A method of manufacturing resin molded product using a manufacturing apparatus comprising:
a movable mold in which a pair of a movable side cavity and a fixed side secondary cavity are formed symmetrically with respect to an axis;
a fixed mold in which a fixed side primary cavity and a side gate are formed;
a primary resin injecting means and a secondary resin injecting means disposed on the side of a fixed mold; and
a decorating film carrying means disposed on the side of the fixed mold,
the method comprising:
a primary forming step of closing the movable mold with respect to the fixed mold and injecting primary resin from a pin gate connected to the fixed side primary cavity by the primary resin injecting means so as to form a primary resin molded product;
a rotating step of opening the molds to separate the movable mold from the fixed mold with the primary resin molded product held and rotating the movable mold around the rotation axis symmetrically with respect to the axis; and
a secondary forming step of, with a decorating film of the decorating film carrying means placed on the fixed side secondary cavity, closing the movable mold with respect to the fixed mold and injecting secondary resin from the side gate between the movable side cavity and the fixed side secondary cavity by the secondary resin injecting means so as to form a decorated secondary resin molded product.

3. A method of manufacturing resin molded product using a manufacturing apparatus comprising:
a movable mold in which a movable side cavity, primary side gate and secondary side gate are formed on each side symmetrically with respect to the axis;
a fixed mold in which a fixed side primary cavity and a fixed side secondary cavity are formed;
a primary resin injecting means and a secondary resin injecting means disposed on the side of a fixed mold; and
a primary decorating film carrying means and secondary decorating film carrying means disposed on the side of the fixed mold,
the method comprising:
a primary forming step of, with a primary decorating film of the primary decorating film carrying means placed on the fixed side primary cavity on the fixed mold, closing the movable mold with respect to the fixed mold and injecting primary resin from the primary side gate between the movable side cavity and the fixed side primary cavity by the primary resin injecting means so as to form a primarily decorated primary resin molded product;
a rotating step of opening the molds to separate the movable mold from the fixed mold with the primary resin molded product held and rotating the movable mold around the rotation axis symmetrically with respect to the axis; and
a secondary forming step of, with a secondary decorated film of the secondary decorated film carrying means placed on the fixed side secondary cavity on the fixed side mold, closing the movable mold with respect to the fixed mold and injecting secondary resin from the secondary side gate between the movable side cavity and the fixed side secondary cavity by the secondary resin injecting means so as to form a secondarily decorated secondary resin molded product.

4. The method of manufacturing resin molded product according to claim 3,
wherein any one of the primary decorating film carrying means and the secondary decorating film carrying means is used.
